(19) United States
(12) Patent Application Publication
(10) Pub. No.: US 2009/0210305 A1
(43) Pub. Date: Aug. 20, 2009

(54) Card system for access to an information web portal

(75) Inventor: Adam Lyons, Phoenix, AZ (US)

Correspondence Address: CARR & FERRELL LLP, 2200 GENG ROAD, PALO ALTO, CA, 94303, US

(73) Assignee: Champion Partners LLC

(21) Appl. No.: 12/156,012

(22) Filed: May 28, 2008

Related U.S. Application Data
(60) Provisional application No. 61/065,992, filed on Feb. 15, 2008.

(51) Int. Cl. G06F 7/06; G06F 17/30; G06Q 30/00

(52) U.S. Cl. 705/14; 707/3; 707/E17.014

(57) ABSTRACT

A system, method, and computer program are provided for card access to an information web portal. An identification code for a project may be generated. The identification code may be assigned to an access card. The identification code may then be received from a user associated with the access card. Content about the project may be provided to the user based on the identification code. In exemplary embodiments, the content may be customized for the user based on the identification code associated with the user.

### CROSS-REFERENCE TO RELATED APPLICATION

The present application claims the priority benefit of U.S. Provisional Patent Application No. 61/065,992, filed Feb. 15, 2008 and entitled “Card System for. Access to an Information Web Portal,” which is hereby incorporated by reference.

### BACKGROUND

1. Field of the Invention

The present invention relates generally to online resources, and more particularly to a card system for access to an information web portal.

2. Background Art

Conventionally, real estate project information has been restricted to real estate developers and individuals and entities working closely with the real estate developers, such as architects. Word of mouth is often relied upon by the real estate developers to inform potential customers about upcoming availability of real estate associated with the real estate project. Advertising is also used to inform potential customers or the general public about the real estate projects.

Unfortunately, word of mouth and advertising typically provide little detailed information about the real estate projects. For example, a pamphlet or billboard often indicates that specific real estate is coming soon at a certain price and often has a name and developer associated with the real estate projects. Individuals or entities that may desire more information about particular real estate projects frequently have to visit the site of the real estate project, call a phone number associated with the real estate project, or access a website with limited information about the real estate project.

### SUMMARY OF THE INVENTION

A system, method, and computer program are provided for card access to an information web portal. In exemplary embodiments, an identification code for a project is generated. Subsequently, the identification code is assigned to an access card. The access cards may then be distributed to various users. Subsequently, the user may provide the identification code associated with the access card to the information web portal. Content about the project may be provided to the user based on the identification code. In some embodiments, the content may be customized for the user based on the identification code. User interaction with the content may also be monitored in some embodiments. As a result, the user may automatically be informed of updates to the content using the registration data according to the monitoring.

### BRIEF DESCRIPTION OF THE DRAWINGS

FIG. 1 is a block diagram an exemplary environment for providing card access to an information web portal.

FIG. 2 is a block diagram of an exemplary project management system.

FIG. 3 is a block diagram of an exemplary content management engine.

FIG. 4 is a flowchart of an exemplary method for providing access to an information web portal.

FIG. 5 is a flowchart of an exemplary method for providing customized content.

FIG. 6 shows an exemplary communication device.

### DESCRIPTION OF EXEMPLARY EMBODIMENTS

Exemplary embodiments of the present invention provide card access to an information web portal. Users can utilize unique identification codes associated with an access card to access content associated with the information web portal. In one embodiment, the information web portal is a real estate web portal providing information on one or more real estate projects. While exemplary embodiments will be discussed in relations to a real estate web portal, the present invention may be practiced with respect to any type of information web portal.

The access cards may be distributed to various types of users, such as potential customers, architects, contractors, and so forth. For example, one set of access cards may be distributed to real estate agents at a trade show, while a second set of access cards may be distributed on a street corner near a real estate development to neighbors. The users can register with a website associated with the access card in order to receive customized content regarding one or more real estate projects. Alternatively or in addition, the user may also receive automatic updates about the real estate project.

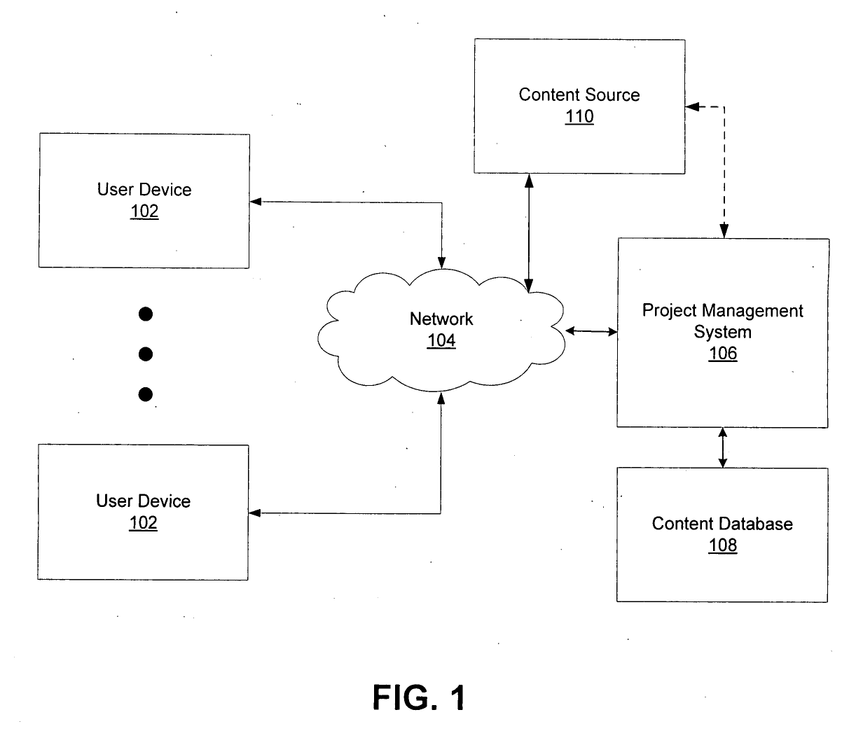

Referring now to FIG. 1, a block diagram of an exemplary environment for providing card access to an information web portal, and more specifically to a real estate web portal, is shown. One or more user devices 102 are in communication via a network 104 with a project management system 106. The user devices 102 may be associated with one or more users, such as potential clients, architects, contractors, or any other individuals interested in receiving information from the project management system 106.

The user devices 102 may include any type of device that has access to the network 104. For example, the user devices 102 may comprise a computing device, a laptop or desktop computer, a cellular telephone, a personal digital assistant (PDA), or any other computing or digital device. The network 104 may comprise, for example, a wide area network, the Internet, or any other type of communications network.

The project management system 106 may be associated with a real estate developer or any other entity that manages real estate projects and/or content associated with real estate projects. The project management system 106 may display or otherwise provide various content stored in a content database 108 associated with the real estate projects, via, for example, a website (e.g., the web portal). For example, the content may comprise blueprints, project layout designs, leases, and so forth. Any type of documents, media, advertisements, incentives, or information may comprise the content. In one embodiment, each real estate project may have a different content database 108 associated therewith. In other embodiments, a single content database 108 may store all content associated with the project management system 106. It should be noted that while the content database 108 is shown coupled to the project management system 106, the content database 108 may be embodied within the project management system 106.

Furthermore, each real estate project may have more than one user interface for distribution of the content. For example, a contractor working on the real estate project may have access to a different set of information for the real estate project than a potential buyer. Thus, embodiments of the present invention may provide a different interface and/or different information to the user based on their user type. In exemplary embodiments, the project management system 106 can identify the user or user type based, in part, on the unique identification code provided on the access card and subsequently associated with the user.

One or more content sources 110 may provide the content to the project management system 106. According to some embodiments, the content may be stored in a database associated with the content sources 110 and/or the content database 108 of the project management system. The content sources 110 may comprise any information source. For example, one or more government agency databases may be the content source 110 for relevant laws, utility considerations, agriculture records, and local economic data. In a further example, a contractor or architect database may be the content source 110 for blueprints, photos, and maps.

The content sources 110 may provide the content via the network 104 or directly to the project management system 106. The project management system 106 may utilize indexes, storage mediums, or any other tools to store and manage the content from the various content sources 110. In some embodiments, the content may be pushed from the content source 110. For example, an architect may make changes to a blueprint and send the updated blueprint to the project management system 106. In other embodiments, the content may be pulled from the content source 110. For example, the project management system 106 may periodically check for updated documents (e.g., a higher version number) from each content source 110.

The content is provided to users associated with the user devices 102 via the network 104. The interaction between the users and the content may be monitored according to exemplary embodiments. According to some embodiments, the project management system 106 monitors the user devices 102 via the network 104. In one implementation, the user devices 102 may periodically couple to the project management system 106 via the network 104 for monitoring. Based on the monitoring, the project management system 106 may automatically send updates or messages regarding updates to the users regarding particular real estate projects (e.g., when a particular user fails to access the updates after a predetermined period of time). The project management system 106 may also generate reports based on the monitoring (e.g., such as how long the users interacted with the content) in order to help determine comprehensibility of the content, to generate work flow, and so forth.

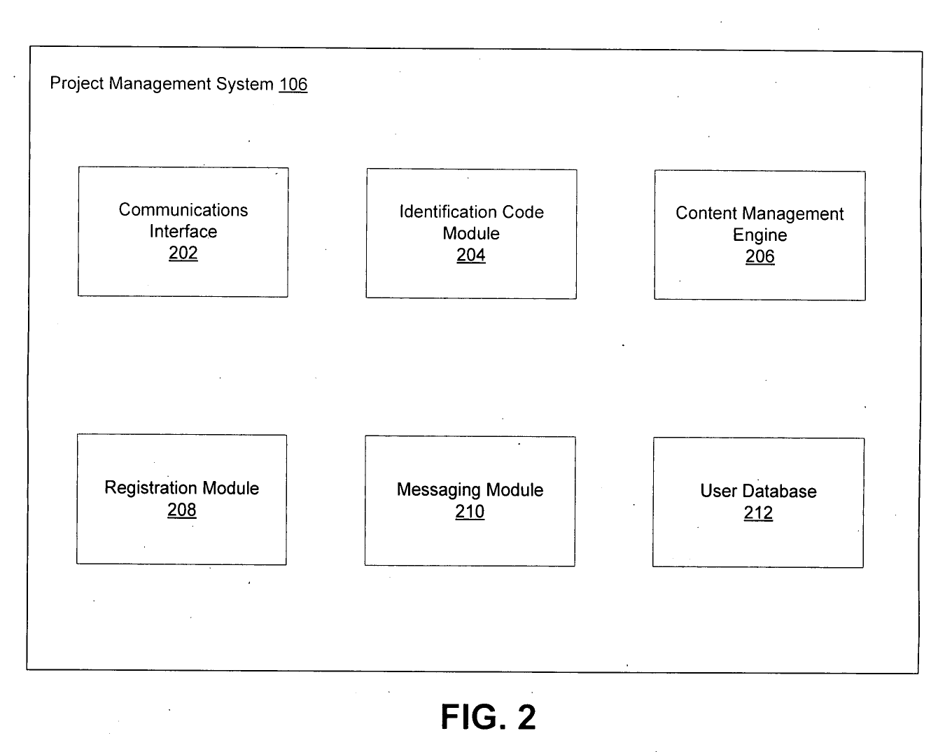

FIG. 2 is a block diagram of the exemplary project management system 106. The exemplary project management system 106 may comprise a communications interface 202, an identification code module 204, a content management engine 206, a registration module 208, a messaging module 210, and a user database 212. Although various modules and engines are shown in FIG. 2, fewer or more modules and engines may comprise the project management system 106 and still fall within the scope of various embodiments. For example, the project management system 106 may comprise databases for content (e.g., content database 108).

In exemplary embodiments, the communications interface 202 facilitates communication between the user devices 102 and the project management system 106. For example, the communications interface 202 may exchange messages, such as emails and text messages with the users associated with the user devices 102. The communications interface 202 may also provide a graphical user interface in association with the website or web portal for accepting user input and displaying various types of output, according to some embodiments.

The exemplary identification code module 204 may generate and maintain a record of identification codes as discussed herein. Each identification code may be a numeric code, an alpha numeric code, or any other type of unique identifier. The identification code may be generated randomly or by any other method. The identification code may then be assigned to an access card (e.g., printed onto a card) or other medium enabled to provide the identification code (e.g., an e-mail or brochure). The identification code may be used to identify one or more individuals or groups associated with the real estate projects.

In one embodiment, the identification code may comprise a plurality of digits (e.g., 11 digits) in which a first series of numbers (e.g., first four numbers) identifies a particular real estate project. The remaining numbers may be associated with an individual (e.g., a potential buyer). In another embodiment, the first series of numbers identifies a particular real estate project, while a second series of numbers identifies a user type (e.g., contractor, potential buyer, real estate agent). Finally, the last set of numbers may be unique to the individual. In exemplary embodiments, the identification code module 204 may maintain a list in a database of identification codes and associations with specific real estate projects. It should be noted that a same type of users may receive cards having the same identification code. For example, all real estate agents may receive cards having the same identification code. However, upon registration, as will be discussed below, the real estate agent may be differentiated (e.g., by user name or password) and begin receiving more customized information.

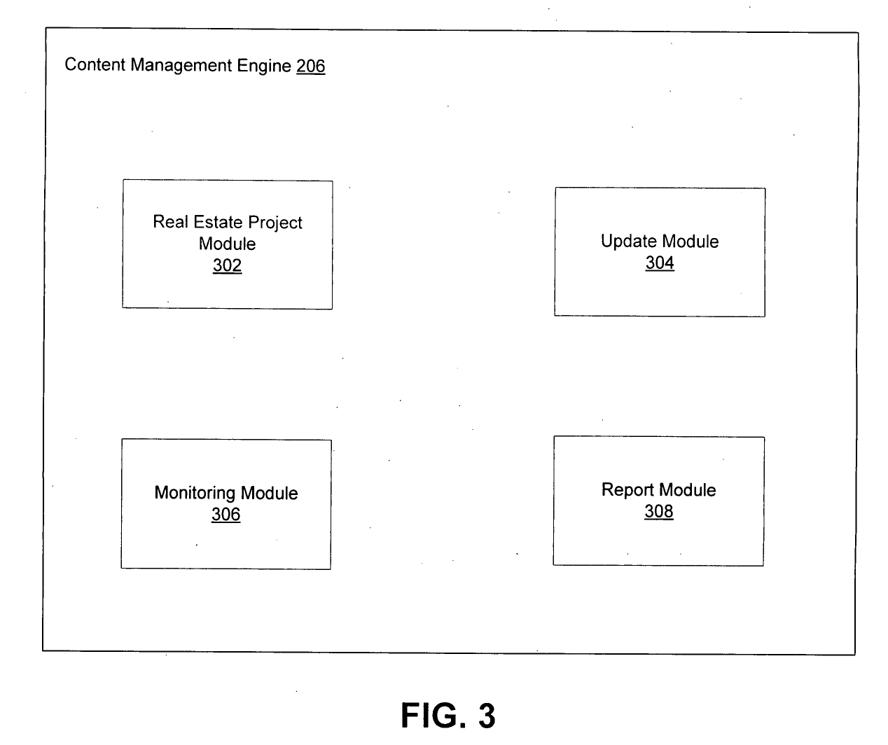

The exemplary content management engine 206 is configured to determine information to provide each user accessing the project management system 106. The content management engine 206 may also customized the information that is to be provided. The content management engine 206 will be discussed in more detail in connection with FIG. 3 below.

The exemplary registration module 208 may be configured to receive the identification code from an access card or other access media distributed to a user. The user may then be registered with the project management system 106. The user may receive the access card with the identification code from any source. For example, the access card may be distributed by persons associated with the real estate developer and/or the project management system 106. The user may access a website associated with the project management system 106 and input the identification code from the access card using one of the user devices 102. In one embodiment, the registration module 208 may then request the user to generate a login and password in order to subsequently access the content associated with the identification code. The login and password along with the entered identification code may be stored in the user database 212.

The registration module 208 may also request additional information from the user, such as contact information (e.g., an email address or a phone number). Any type of contact information may be requested by the registration module 208. The contact information may then be utilized to communicate with the user in the future regarding the particular real estate project or for any other reason. The registration module 208 may also request other information, such as financial information from a prospective buyer. The additional information may also be stored in the user database 212.

Once the registration of the user is complete, the registration module 208 may instruct the content management engine 206 to allow the user access to content associated with the particular project indicated by the identification code provided on the access card.

In further embodiments, the registration module 208 may log a user into the project management system 106. For example, the registration module 208 may receive a login (e.g., user name) and password from a registered user, and verify the login and password based on data stored in the user database 212. In this way, the user is associated with the identification code without having to enter the identification code every time the user accesses the project management system 106.

The exemplary messaging module 210 may communicate various messages in various formats to the users regarding the real estate projects. For example, the messaging module 210 may send a confirmation of registration to the user via the communications interface 202 based on a communication from the registration module 208. The messaging module 210 may also send an email, text message, or initiate a phone call or email to notify users of updates that users may have failed to access within a predetermined time period. According to some embodiments, the messaging module 210 may automatically distribute the updates to the users that fail to access the updates via the project management system 106, such as by emailing or text messaging a link to the updates on a website associated with the project management system 106.

Referring now to FIG. 3, the exemplary content management engine 206 is shown in more detail. The content management engine 206 is configured to determine appropriate information to provide users based, at least, on the identification code associated with the user. In exemplary embodiments, the content management engine 206 may comprise a real estate project module 302, an update module 304, a monitoring module 306, and a report module 308.

In exemplary embodiments, the real estate real estate project module 302 defines each real estate project and assigns the content to the particular real estate project to which the content pertains. The real estate real estate project module 302 may also access the appropriate content for the particular real estate project when a user requests information about the particular real estate project. For example, the user may log into a website associated with the project management system 106. The real estate real estate project module 302 may use the identification code input by the user to identify the content for the particular real estate project to provide to the user. Alternatively, a registered user may be identified based on a user identifier (e.g., login or user name) and/or password after initially registering using the identification code.

Each identification code or portion of the identification code may be associated with a different real estate project. Accordingly, an access card with an identification code associating the card with a particular real estate project may be distributed to an intended audience of the particular real estate project. In exemplary embodiments, the identification code may comprise a unique numeric code. The unique numeric code may be generated randomly or according to any method. In other embodiments, the identification code may comprise a combination of numbers, letters, and/or special characters.

According to some embodiments, the identification code or portion of the identification code may be directed to a particular marketing opportunity. The card with the identification code may be distributed to different people based on the marketing opportunity. In some embodiments, the real estate project module 302 may provide customized content based on the identification code. In accordance with one embodiment, the real estate project module 302 may determine what type of user (e.g., real estate agent, contractor, potential buyer) is accessing the web portal. Subsequently, a customized user interface may be provided. For example, a welcome message may be provided to a user who, based on the identification code, visited the developer at a trade show (e.g., “Thanks for visiting us at the trade show. Here is more information about us.”). The real estate project module 302 may, in some embodiments, track the information accessed by the user and provide or highlight new information for the user.

According to some embodiments, the identification code indicates which type of “electronic brochure” the recipient of the access card should be presented. The electronic brochure may include any of the content associated with a real estate project or any other type of project discussed herein. Furthermore, the electronic brochure may be customized for a user or group of users based on the identification code.

In one instance, a group of people at a trade show may receive access cards each with an identification code for a strip mall building project, and a group of people in a neighborhood close to the future location of the strip mall building project may also receive access cards having identification codes for the strip mall building project. However, the identification codes of the strip mall building project may be coded differently for the two intended audiences (i.e., group of people at the trade show versus the group of people in the neighborhood). As a result, the two different intended audiences may be presented with different content or electronic brochures about the same strip mall building project.

For example, the trade show group may be presented with content about the contractors, subcontractors, and type of materials being utilized related to the strip mall project. The content interface may be further customized to the individual or group, for example, by referring to the event in which the user received the card (e.g., “Thanks for visiting us at the trade show.”).

In contrast, the neighborhood group may be presented with information about stores that will occupy the strip mall building project, coupons for the future stores, opportunities to lease, and so forth. The content may also be customized to the neighborhood group and to registered individuals within the neighborhood group (e.g., “Exciting changes coming soon to your neighborhood, Jack. Please visit us again for updates.”). Any type of content may be presented to one or more groups associated with a single real estate project. As discussed herein, the identification code or a portion of the identification code may differ for each group or individual associated with the same real estate project.

The exemplary update module 304 may be configured to receive information for new or existing real estate projects. The update module 304 communicates with the real estate real estate project module 362 in order to assign the information or updates to the real estate projects. For example, the update module 304 may identify the real estate project to which changes to a particular blueprint belong based on information provided along with the changes (e.g., information from the user or the content source 110 providing the update). The changes to the blueprint are then identified as a new version of the blueprint or an update to the content associated with the real estate project. The update module 304 may communicate with various other modules associated with the project management system 106 in order to distribute the content or inform users about the updates. The information may be uploaded to the update module 304 (e.g., pushed from the content source 110) or pulled by the update module 304.

In some embodiments, histories associated with each of the real estate projects may be maintained by the update module 304. For example, various versions of the content associated with the particular real estate project may be maintained by the update module 304. The project management system 106 may utilize a database or communicate with a separate storage device in order to maintain the content and various versions of the content, as discussed herein. In an alternative embodiment, the real estate project module 302 may maintain the histories.

The monitoring module 306 may track the user's interaction with the content. The monitoring module 306 may track instances and duration of user logs in, what content the user views, if the user provides and feedback, and so forth. The monitoring module 306 may also track the user's behavior with respect to updates. For example, when the monitoring module 306 is informed of updates to the content for a particular project by the update module 304, the monitoring module 306 may monitor the user for a period of time after the update is made available. If the user fails to access the updates during the period of time, the monitoring module 306 may instruct the messaging module 210 to contact the user (e.g., by email, text message, phone, or other contact mechanism) and notify the user that updates to the real estate project are available. Any schedule or period of time may be specified for the monitoring module 306 to determine when enough time has lapsed between the update and the user's failure to access the update.

The monitoring module 306 may also track user interaction with the content for further analysis. For example, the monitoring module 306 may track how long a user viewed the content. The user interaction with the content may be monitored in order to determine comprehension of the content, to generate work flow, to identify areas of greatest interest within the real estate project, and so forth.

The report module 308 may generate reports for the real estate developer or other individuals associated with the project management system 106. For example, the report module 308 may receive analysis data from the monitoring module 306 and generate a report indicating which users normally access updates and how long these users view the updates.

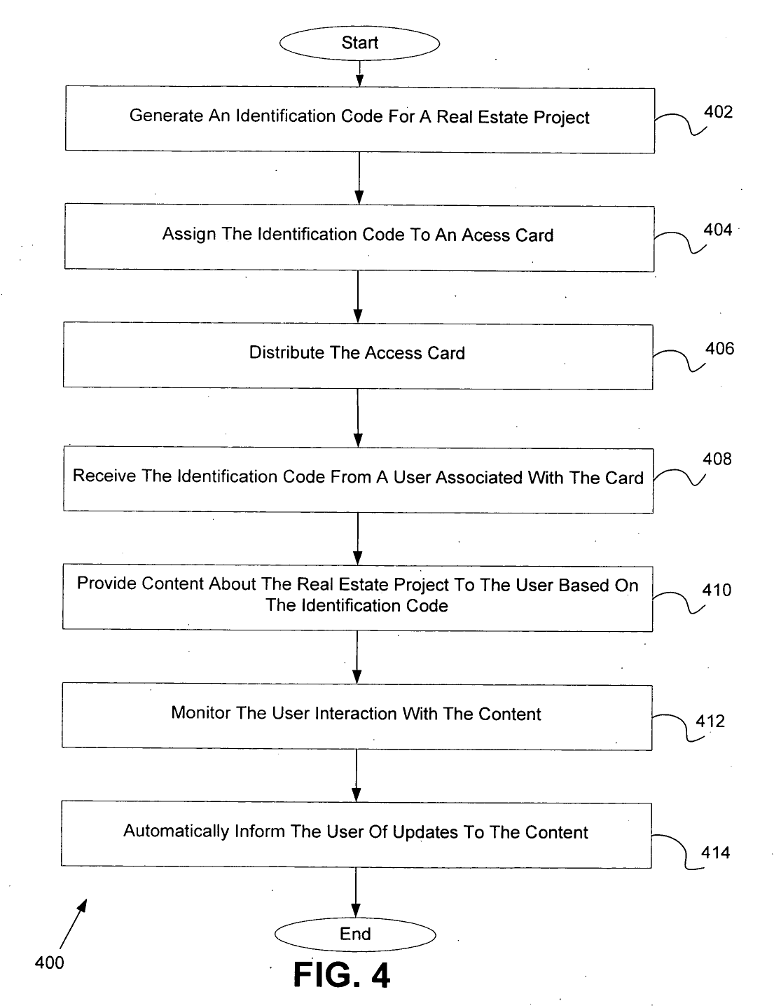

FIG. 4 is a flowchart 400 of an exemplary method for providing card access to a real estate web portal. In step 402, an identification code for a real estate project is generated. According to some embodiments, the identification code may be generated for other types of projects not associated with a real estate industry. As discussed herein, any type of identification code may be generated, such as a unique numeric code, a unique alpha-numeric code, or any other type of unique identifier. A portion of the identification code may be unique and another portion of the identification code may be common to a group or type of user (e.g., a group of real estate agents). For example, the first four numbers of the identification code may be common to a particular real estate project, so that distributors of the card may be able to easily determine the real estate project in order to distribute the card to an intended audience. In some embodiments, the remaining portion of the identification code may be unique in order to associate the identification code to an individual or group of individuals. The identification code may indicate to which real estate project or to which of the content associated with a particular real estate project access should be granted.

In step 404, the identification code is assigned to an access card or other access media. In exemplary embodiments, the identification code may be printed on, embossed, or otherwise associated with the access card. Alternatively, the identification code may be provided on other access media (e.g., e-mail, brochures). The identification codes may be utilized by the individuals or entities to access information about real estate projects, such as by accessing a website associated with the project management system 106. The access media may be used as advertising tools in order to market the various real estate projects, for example.

The identification code may also be stored in a database or other storage associated with the project management system 106. As a result, the project management system 106 may be able to identify the real estate project associated with the access card so the appropriate content may be provided to the user receiving the access card.

In step 406, the access card or other access media is distributed. The access media may be physically distributed in accordance with some embodiments. For example, a real estate developer may hand out access cards or brochures having identification codes at a trade show. Alternatively, the access media may be electronically distributed. For example, the real estate developer may send an e-mail comprising the identification code. As another example, a subcontractor may be provided with an access card by a contract which will provide access to information about an upcoming business complex that the subcontractor may like to participate in building. Any method of card distribution may be utilized.

In step 408, the identification code is received from a user who receives the access card or access media. The user may utilize the user device 102 discussed herein to access a website associated with the project management system 106. The user then inputs the identification code associated with the access card. This identification code may be utilized to determine an appropriate level of access to content associated with a particular real estate project and/or customized information to be provided to the user.

The user may also be prompted for registration data. For example, the user may provide a login, a password, and contact information to the project management system 106, as discussed in association with the registration module 208.

In exemplary embodiments, the project management system 106 may require the identification code, login and password, and/or any other unique identifier for future access to the content by the user. The project management system 106 may require different registration information and/or access information for different groups of users. For examples, users that may access the content frequently, such as architects and real estate agents associated with the real estate project, may not be asked for the identification code associated with the card during future visits to access the content. In contrast, users, such as potential customers, may always be asked for the login, password, and the identification code during future visits to access the content, for example.

In step 410, content about the real estate project is provided to the user based on the identification code and the registration data. As discussed herein, the content may comprise any type of literature, documents, media, video, audio, relevant laws, zoning, public records, maps, photos, and so forth associated with the real estate project. Each real estate project may have different types of the content associated with the real estate project. The content may be obtained from any content source 110 via the network 104 or otherwise.

In step 412, the user interaction with the content may be monitored. The monitoring module 306 may monitor user activity, such as the user's interaction with the content, as discussed herein. The monitoring may occur according to a schedule or according to an event, such as after updates are posted relative to a particular real estate project. Furthermore, the user interaction may be analyzed to determine length of time spent with the content, interest in the various types of content, and so forth. According to some embodiments, a report may be generated based on the analysis. The analysis and/or the report may be utilized, for example, to generate workflows, or to manage other real estate projects.

In step 414, the user may be automatically informed of updates to the content according to the monitoring. The monitoring module 306 may determine that a time period has elapsed between the posting of updates (e.g., adding to or revising the content) that requires a message to the user that failed to access the updates. The monitoring module 306 may instruct the messaging module 210 to send a message (e.g., an email, text message, or phone call) to the user or personnel associated with the project management system 106 that the updates are available to the user. According to some embodiments, informing the user of the updates to the content may include sending the user one or more links to the updates.

The messaging module 210 may also send incentives, coupons, or advertisements associated with the real estate project, for example, to the user based on the monitoring. For example, if the user has not logged in to access the content for a predetermined period of time, the monitoring module 306 may instruct the messaging module 210 to send a coupon for a future business opportunity associated with the real estate project, in order to renew the user's interest in the real estate project. In some embodiments, incentives may be sent to the user or provided via the website regardless of whether the user accesses the updates.

It should be noted that the embodiment of FIG. 4 is exemplary. Alternative embodiments may provide more, less, or functionally equivalent steps. For example, steps 412 and 414 may be optional or removed from the method of FIG. 4.

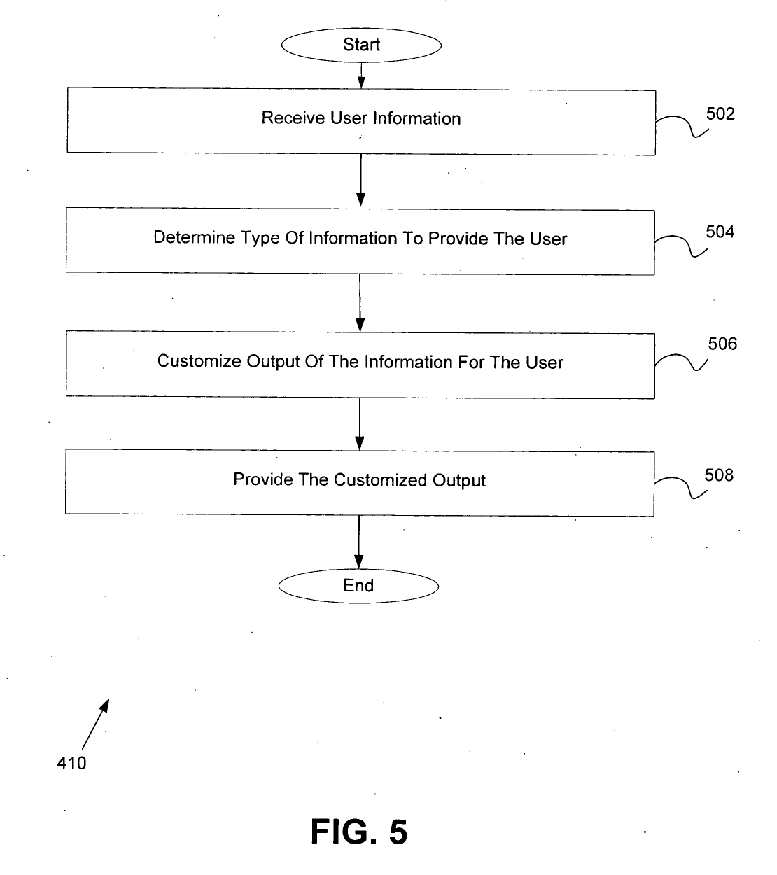

Referring now to FIG. 5, a flowchart of an exemplary method for providing customized content (step 410) is shown. In step 502, user information is received by the content management engine 206. For example, the user may provide the identification code to the registration module 208. Subsequently, the identification code or associated user information (e.g., login or user type) is forwarded to the content management engine 206.

In step 504, content management engine 206 determines the type of information to provide the user. In exemplary embodiments, the real estate project module 302 will access the content database 110 and based on the identification code or associated user information determine and retrieve the proper information. The proper information may be determined based on the user type (e.g., contractor, potential buyer, real estate agent) and/or on specific user identity. For example, if the user is registered with the project management system 106, then the information may comprise updates since the user's last visit.

In step 506, the information may be customized for output to the user. In one embodiment, a particular user may be provided a user interface that is customized to the user's type. For example, a contractor may be provided a user interface that provides access to blue prints, subcontractor bids, and work schedules organized in a certain way. In contrast, a potential buyer may be provided a user interface that is graphically more appealing and provides links to government websites providing education, economic, and utility information along with sales information about the real estate development. Once customized, the output is provided to the user in step 508.

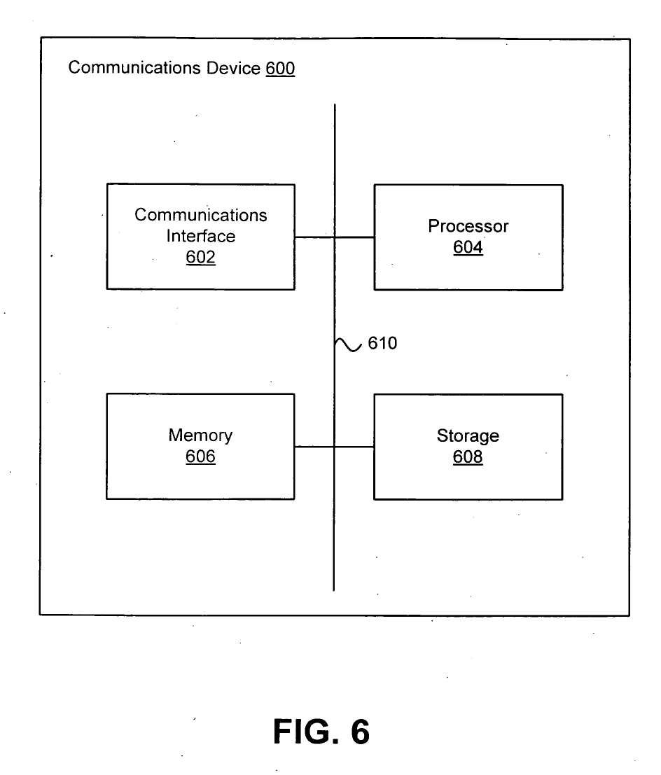

FIG. 6 shows an exemplary communication device 600. The communication device 600 may comprise the project management system 106 or the user devices 102 according to exemplary embodiments. The communication device 600 comprises at least a communications interface 602, a processor 604, a memory 606, and storage 608, which are all coupled via a bus 610. The bus 610 provides communications between the communications interface 602, the processor 604, the memory 606, and the storage 608. The processor 604 executes instructions, while the memory 606 permanently or temporarily stores data. Some examples of the memory 606 are RAM and ROM. The storage 608 also permanently or temporarily stores data. Some examples of the storage 608 are hard disks and disk drives. In various embodiments, the modules and engines described in connection with FIG. 2 may be embodied with the memory 606 and/or the storage 608.

The above-described components and functions can be comprised of instructions that are stored on a computer-readable storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with the invention. Those skilled in the art are familiar with instructions, processor(s), and storage medium.

While various embodiments have been described above, it should be understood that they have been presented by way of example only, and not limitation. For example, any of the elements associated with the project management system 106 may employ any of the desired functionality set forth hereinabove. Thus, the breadth and scope of a preferred embodiment should not be limited by any of the above-described exemplary embodiments.

What is claimed is:

1. A method for providing access to an information web portal comprising:
receiving a unique identification code from a user, the identification code being associated with a particular project;
determining customized content to provide to the user based at least on the identification code associated with the user; and
providing the customized content to the user.

2. The method of claim 1 further comprising generating the unique identification code associated with the particular project.

3. The method of claim 1 further comprising assigning the unique identification code to an access medium, whereby the access medium may be distributed to one or more users.

4. The method of claim 3 wherein the access medium is an access card.

5. The method of claim 1 wherein providing customized content comprises customizing the content for an individual based on the identification code associated with the individual.

6. The method of claim 1 wherein providing customized content comprises customizing the content for a group based on the identification code associated with the group.

7. The method of claim 1 wherein providing customized content comprises providing a customized interface to the user based on the identification code associated with the user.

8. The method of claim 1 wherein the particular project comprises a real estate project and the customized content comprises customized real estate content.

9. The method of claim 1 further comprising receiving registration information for the user, the registration information being associated with the identification code.

10. The method of claim 1 further comprising monitoring the user's interaction with the customized content.

11. The method of claim 1 further comprising providing notification of updates to the customized content.

12. The method of claim 1 further comprising distributing incentives to the user based on the associated identification code.

13. The method of claim 1 further comprising receiving, storing, and managing content associated with the particular project.

14. A system for providing access to an information web portal comprising:
a registration module configured to receive a unique identification code from a user, the identification code being associated with a particular project;
a project module configured to determine customized content to provide to the user based at least on the identification code associated with the user; and
a communication interface configured to provide the customized content to the user.

15. The system of claim 14 further comprising an identification code module configured to generate the unique identification code for the particular project.

16. The system of claim 14 further comprising a monitoring module configured to monitor the user interaction with the content.

17. The system of claim 14 further comprising a messaging module configured to provide messages to the user regarding the content.

18. The system of claim 14 further wherein the project module is further configured to generate a unique interface to provide the customized information to the user.

19. The system of claim 14 wherein the project module comprises a real estate project module configured to provide customized real estate information based on the identification code associated with the user.

20. A machine readable medium having embodied thereon a program, the program providing instructions for performing a method for providing access to an information web portal, the method comprising:
receiving a unique identification code from a user, the identification code being associated with a particular project;
determining customized content to provide to the user based at least on the identification code provided by the user; and
providing the customized content to the user.
